(19) United States
(12) Patent Application Publication
(10) Pub. No.: US 2005/0023822 A1
(43) Pub. Date: Feb. 3, 2005

(54) Sheet articles

(76) Inventor: George Wallace MCDonald, Channel Islands (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/495,046

(22) PCT Filed: Nov. 7, 2002
(86) PCT No.: PCT/GB02/05032

(30) Foreign Application Priority Data
Nov. 8, 2001 (GB) 0126832.5

(51) Int. Cl. B42D 15/00

(52) U.S. Cl. 283/106

(57) ABSTRACT

The invention provides a sheet article (2) comprising a cover comprising hingedly connected first and second surfaces (6, 8), wherein on the inside of the cover is connected a sheet material having a first set of folds, and wherein the second surface (6) comprises a pocket (16) on the inside of the second surface, the opening of the pocket facing the hinged connection between the first and second surfaces.

### FIELD OF THE INVENTION

The present invention relates to sheet articles. The invention also relates to kits comprising sheet articles.

### BACKGROUND TO THE INVENTION

It is known to provide sheet articles comprising card covers having first and second surfaces folded over to provide front and back covers, and which include a pocket formed on the inside of one of the covers. It is also known for such items to comprise a plurality of sheets glued into the fold of the cover to provide a booklet flanked by the front and back covers.

U.S. Pat. No. 6,120,228 (Exline) discloses a wallet size pocketed booklet having front and back covers formed from a single sheet of material folded over, and including a plurality of sheets forming a booklet glued to said fold. The front cover also has a pocket glued thereon, and wherein the opening of the pocket faces transverse to the fold of the cover. Articles placed in the pocket can inadvertently slip out of the pocket, and as the opening of the pocket faces away from the fold, and therefore away from the cover, the article is free to fall out of the pocket without much hindrance. Furthermore, the information stored within the booklet is presented on a plurality of sheets, which are relatively difficult to access, and only certain pieces of the information may be read at one time, with the user having to flick through the sheets to locate further pieces of information.

U.S. Pat. No. 6,089,608 (Exline) discloses a wallet size card booklet comprising a cover having front and back covers separated by a fold therebetween. The booklet also comprises a pocket formed on the inside of the front cover, with the opening facing towards the fold of the cover. The booklet also comprises a plurality of sheets glued into the fold and extending away from the fold to provide the booklet. Although the provision of a pocket having an opening facing towards to the fold means that there is much less likelihood of an article which has been inserted into the pocket from inadvertently falling out of the booklet, the same problems remain relating to the provision of information in booklet form.

U.S. Pat. No. 5,595,401 (Exline) discloses a wallet size card booklet comprising a cover having front and back surfaces folded over therebetween. The cover includes a pocket formed on the inside of front cover, the pocket having an opening facing perpendicular to the axis of the fold of the cover. The cover also includes a plurality of sheets glued into the fold which form the booklet. Again, any article placed within the pocket of the booklet may inadvertently slip out of the pocket due to the fact that the opening of the pocket faces away from the cover, there being no security provision to prevent articles from inadvertently falling out. Furthermore, the provision of the information in a booklet form again leads to problems in locating specific pieces of information, and being able to print larger pieces of information on a single booklet sheet.

It is therefore an aim of preferred embodiments of the invention to overcome or mitigate at least one of the problems associated with the prior art, whether explicitly disclosed herein or not.

### SUMMARY OF THE INVENTION

According to the present invention in a first aspect, there is provided a sheet article comprising a cover comprising hingedly connected first and second surfaces, wherein on the inside of the cover is connected a sheet material having a first set of folds, and wherein the second surface comprises a pocket on the inside of the second surface, the opening of the pocket facing the hinged connection between the first and second surfaces.

Suitably the sheet material is connected to the inside of the first surface.

Alternatively the sheet material may be connected to the pocket on the inside of the second surface.

Preferably the first set of folds is concertina folds.

Suitably the sheet material further comprises at least one fold transverse to the first set of folds, preferably a second set of folds. Preferably the second set of folds is concertina folds.

Suitably the sheet material is provided with a stiff portion at a segment thereof.

Suitably the sheet material is connected to the first surface at a segment of the sheet at one corner of the sheet the segment being defined by fold(s) or edge(s) of the sheet.

Preferably the segment at which the stiff portion is provided is at another corner of the sheet material and is defined by fold(s) or edge(s) of the sheet.

Preferably the first and second surfaces are formed from a single surface comprising a fold therein, the fold forming the hinged connection between the first and second surfaces.

Alternatively the first and second surfaces may comprise separate surfaces hingedly connected, which may, for example, be by way of gluing, stitching, stapling, binding or the like or by way of a separate connecting member or surface, for example; or by way of the sheet material itself.

Preferably the pocket is formed from a portion of the second surface folded in on itself, and sealed to the second surface to form a pocket. Suitably the pocket is sealed to the second surface by gluing, stitching, stapling, binding or the like.

Alternatively the pocket may be formed from a separate surface connected to the inside of the second surface of the cover such that an opening is formed. The separate surface may be connected by any suitable means, such as gluing, stitching, stapling, binding or the like.

The pocket may comprise a separate distinct pocket which is attached to the inside of the second surface. The separate pocket may be attached by gluing, stitching, stapling, binding or the like.

Suitably the pocket is formed such that it comprises no free edges within the interior of the pocket.

The edge of the opening of the pocket may comprise a recessed or cut-out portion, to enable a user to more easily grasp an article placed in-the pocket.

The pocket may comprise means to retard accidental egress of an article from the pocket, but allow deliberate removal therefrom.

According to the present invention in a second aspect there is provided a sheet article comprising a cover comprising hingedly connected first and second surfaces, and wherein the second surface comprises a pocket on the inside of the surface, the opening of the pocket facing the hinged connection between the first and second surfaces, and wherein the sheet article comprises a tongue extendable from the first surface into the pocket of the second surface, the distance of extension of the tongue into the pocket being adjustable by relative movement of the first and second surfaces about the hinged connection.

Suitably the sheet article further comprises a sheet material connected to the inside of the cover.

The sheet material may be connected to the pocket on the inside of the second surface.

Suitably the sheet material is connected to the inside of the first surface of the cover.

The sheet material may comprise a plurality of sheets which are connected to form a booklet.

Preferably the sheet material comprises a sheet material comprising a first set of folds, preferably concertina folds. The sheet material is preferably as described for the first aspect of the invention.

Suitably the pocket is as described for the first aspect of the invention.

The cover and first and second surfaces may be as described for the first aspect of the invention.

Suitably the tongue comprises a portion of the first surface folded in on itself. Alternatively the tongue may comprise a separate surface connected to the first surface of the cover.

Suitably the tongue comprises a retaining member for operatively retaining an article inserted into the pocket during movement of the tongue within the pocket.

Preferably the tongue is moveable between a first position in which a retained article protrudes a first distance from the pocket, and a second position in which a retained article protrudes a second distance from the pocket, and wherein the second distance is greater than the first distance. Preferably when the tongue is in the first position, a retained article does not protrude across the hinged connection between the first and second surfaces of the cover.

In the second position, a retained article may protrude past the hinged connection between the first and second surfaces.

Suitably the retaining member comprises a portion of the tongue, and preferably in the region of the distal end of the tongue, folded in on itself to provide a recess in which an article may be retained. Alternatively the retaining member may comprise a separate member connected to the tongue.

Preferably the pocket is dimensioned such that it can accommodate credit-card sized articles. By credit-card sized articles we mean items that are substantially 8½ cm long by 5 cm wide. Suitably the pocket has dimensions slightly larger than credit-card sized articles to allow the articles to fit easily and snugly into the pocket.

According to a third aspect of the present invention there is provided a sheet article comprising a cover comprising hingedly connected first and second surfaces, wherein the cover comprises a sheet material connected to the inside of the cover, the second surface comprises a pocket, with the opening of the pocket facing the hinged connection between the first and second surfaces, and wherein the second surface comprises a second hinge which is rotatable to enable a marginal portion of an item inserted in the pocket to be presented.

The pocket may be connected on the inside of the second surface or the outside of the second surface.

Suitably the sheet material is connected to the inside of the first surface.

Alternatively the sheet material may be connected to the pocket on the inside of the second surface.

The sheet material may comprise a plurality of sheets which are connected to form a booklet, but preferably the sheet material is a sheet material comprising a first set of folds preferably concertina folds.

The sheet material is preferably as described as for the first and/or second aspects of the invention.

Suitably the second hinge is located between the opening of the pocket, and the hinged connection of the first and second surfaces.

Preferably the second hinge comprises a fold in the second surface.

The pocket is preferably as described for the first and/or second aspects of the invention.

The cover and first and second surfaces may be as described for the first aspect of the invention.

### BRIEF DESCRIPTION OF THE DRAWINGS

The present invention will now be described, by way of example only, with reference to the following drawings, in which:

FIG. 1 illustrates a plan view of a first embodiment of a sheet article in accordance with the present invention.

FIG. 2 shows a plan view of a second embodiment of a sheet article according to the present invention;

FIG. 3 illustrates a plan view of a third embodiment of a sheet article according to the present invention;

FIG. 4 illustrates a plan view of a fourth embodiment of a sheet article according to the present invention;

FIG. 5A shows a side sectional view taken through the line A-A of the sheet article of FIG. 4, with the sheet article in a first, partly unfolded state; and

FIG. 5B shows a side sectional view taken through the line A-A of FIG. 4, with the sheet article in a second, partly folded state.

FIG. 6 illustrates a side sectional view of a fifth embodiment of a sheet article according to the present invention;

FIG. 7 illustrates a plan view of a sixth embodiment of a sheet article according to the present invention;

FIG. 8 illustrates a plan view of the embodiment shown in FIG. 7 having a card article inserted into the pocket;

FIG. 9 illustrates a plan view of a seventh embodiment of a sheet article according to the present invention;

FIG. 10 illustrates a plan view of the embodiment shown in FIG. 9 having a card article inserted into the pocket;

FIG. 11A illustrates a side sectional view through the line B-B of FIG. 10, in a first partly unfolded state, with the card article extending towards the fold of the cover;

FIG. 11B illustrates a side sectional view through the line B-B of FIG. 10, in a second partly unfolded state, with the second hinge of the first surface of the cover rotated to present the marginal portion of the card article away from the cover;

FIG. 12 illustrates a plan view of an eighth embodiment of a sheet article according to the invention;

FIG. 13 illustrates a plan view of a ninth embodiment of a sheet article according to the invention;

FIG. 14 illustrates a plan view of a tenth embodiment of a sheet article according to the invention;

FIG. 15 illustrates a plan view of a shaped card sheet for use as a pocket to be attached to a sheet article of the present invention;

FIG. 16 illustrates a plan view of an eleventh embodiment of a sheet article according to the invention; and

FIG. 17 illustrates a plan view of a twelfth embodiment of a sheet article according to the invention.

### DESCRIPTION OF THE PREFERRED EMBODIMENTS

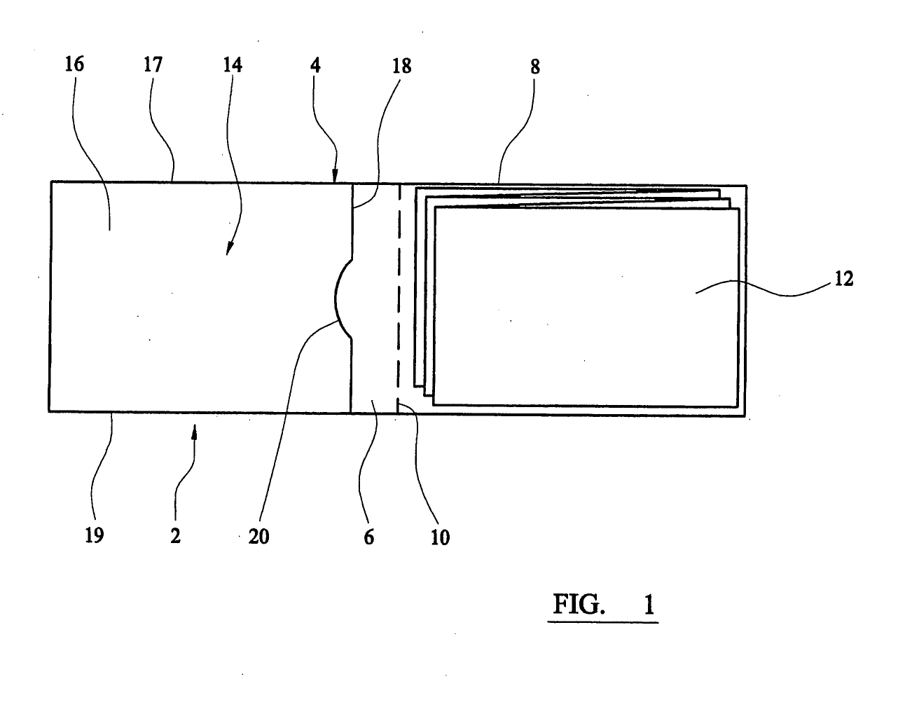

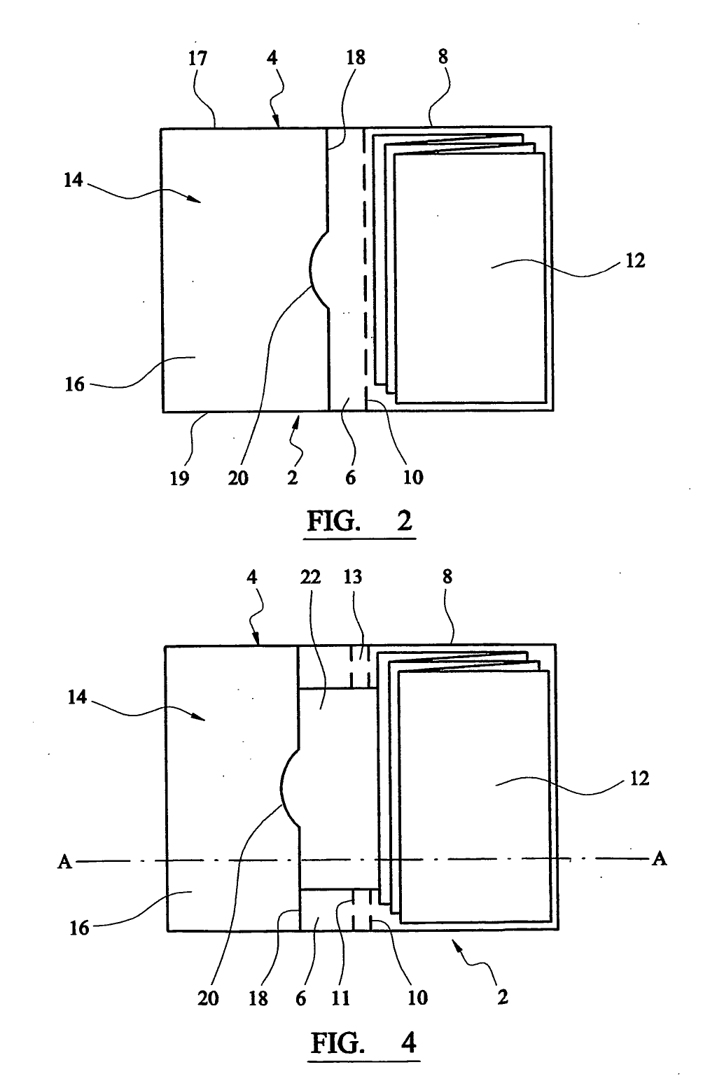

Referring firstly to FIGS. 1 and 2 a sheet article 2 comprises a cover 4 which includes a first surface 6 and a second surface 8 formed from the same sheet material, and hingedly connected about a fold 10 formed in the cover 4. On the inside of the first surface 8, a concertina folded sheet material 12 is connected. The second surface 6 includes a pocket 14 which comprises a pocket cover 16 formed by folding over a portion of the second surface 6, and gluing the side edges 17 and 19 of the folded over pocket cover 16 to the second surface, to form the pocket 14. In this configuration, the opening 18 of the pocket, faces towards the fold 10 between the first surface 8 and the second surface 6. The opening 18 also includes a thumb cut 20.

In both FIGS. 1 and 2, the sheet article 2 comprises a pocket 16 which is approximately credit-card sized, and is arranged to accommodate a credit-card sized item, such as a credit-card or information card of similar size. The sheet articles 2 of FIGS. 1 and 2 differ only in the orientation of first surface 8, second surface 6 and pocket 16, in that in FIG. 1 the cover 4 is hingedly connected with the first 8 and second 6 surfaces in a landscape orientation compared to the cover 4 in FIG. 2 in which the first 8 and second 6 surfaces are oriented in a portrait orientation. Thus, credit-card sized items arranged to be inserted into the pocket 14 of FIG. 1 will be inserted by inserting one of the shorter edges of the credit-card sized item first, whereas for the sheet article 2 of FIG. 2, the credit-card sized item will be inserted with one of the longer edges entering the pocket 14 first.

As the edge of the edge 18 of the opening of the pocket 14 in the sheet articles 2 of both FIGS. 1 and 2 faces towards the fold 10 of the cover 4, when an item is inserted into the pocket 14, and the cover 4 folded about the fold 10, the credit-card sized item is effectively secured in the pocket 14, and cannot be inadvertently removed, or slip out, due to the barrier effect of cover 4 and fold 10. Furthermore, in this configuration the concertina folded sheet material 12 allows a large amount of information to be placed on the sheet material, which can be viewed at any one time by simply unfolding the concertina material to provide a large surface area sheet having a maximum amount of information presented to the viewer at any one time. This overcomes the problem of providing information on leaves in a booklet, which must be leafed through in order to find relevant information. Further, the spine of a leafed booklet may interfere in the extraction of an item from opening 18.

In an alternative embodiment (not shown) to those illustrated in FIGS. 1 and 2, the sheet material 12 may be connected on the pocket 14, rather than the first surface 8.

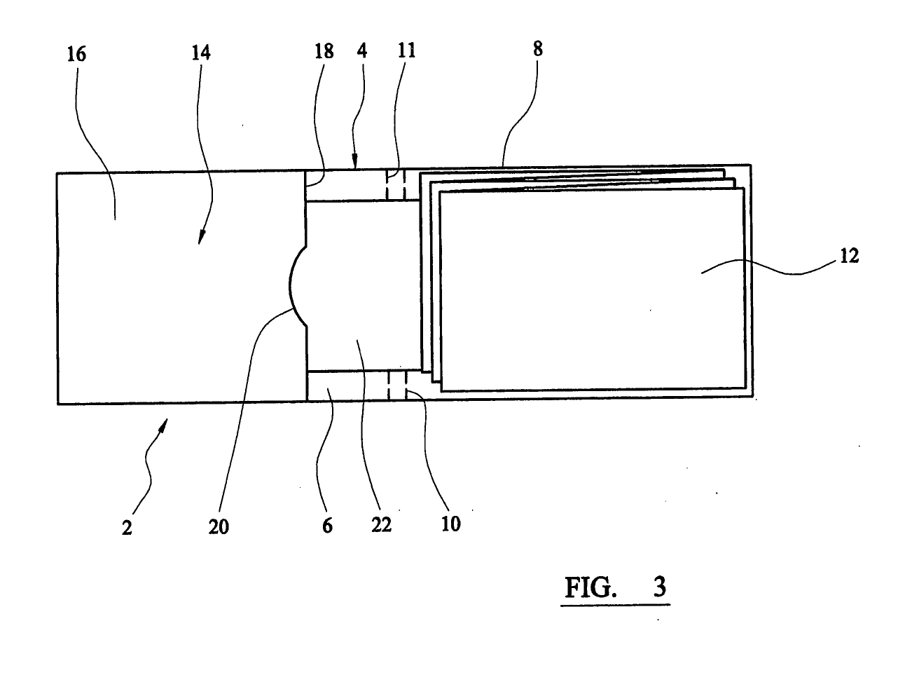

We refer now to FIGS. 3, 4, 5A and 5B, which comprise sheet articles 2, that are similar to sheet articles of FIGS. 1 and 2. Like numerals represent like components. In the embodiments of the sheet articles 2 shown in FIGS. 3 and 4, the cover 4 comprises a first surface 8 and a second surface 6 hinged two folds 10 and 11. The sheet articles 2 also comprise a tongue 22 which is connected to the first surface 8 at pivot 9 by gluing. The tongue 22 extends into the pocket 14. The tongue 22 also includes a retaining member 24 in the form of a folded over portion of tongue 22 at its distal, free end within the pocket 14.

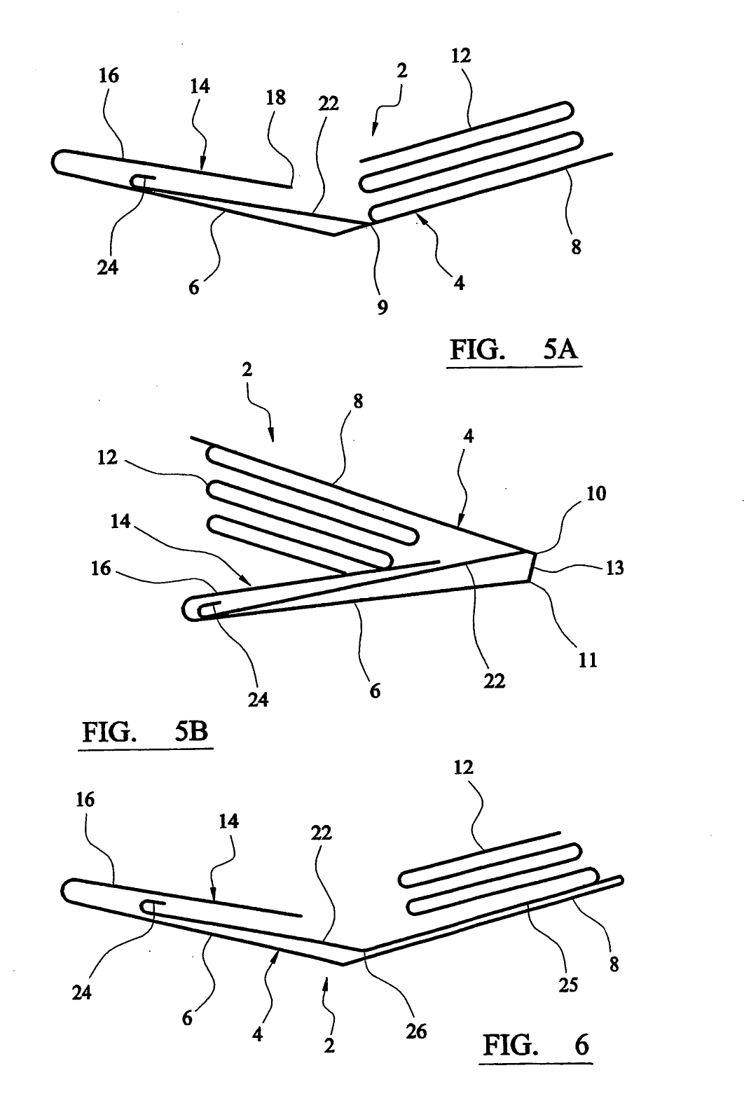

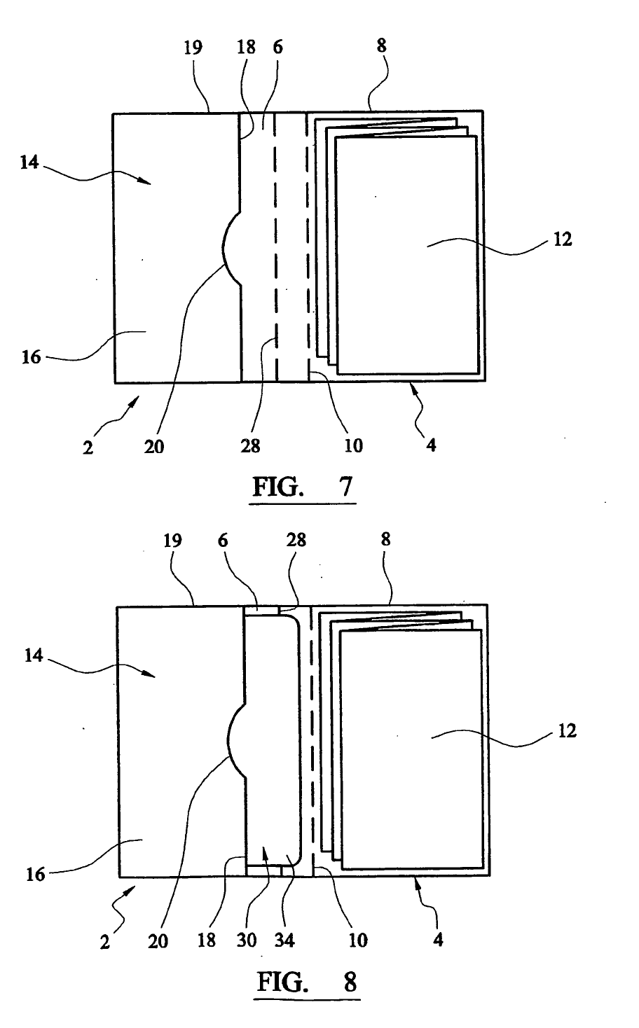

In use, the cover 4 of the sheet article 2 is unfolded about the fold 10, such that the first and second surfaces 8 and 6 are at an obtuse angle, as shown in FIG. 5A. In this position, a credit-card sized item may be inserted into the pocket 14, on top of the tongue 22, until it abuts the recess formed by the retaining member 24.

When it is desired to close the sheet article 2, the first and second surfaces 8 and 6 are folded towards each other about fold 10. As the first and second surfaces 8 and 6 come together, the tongue 22 pivots about the pivot point 9, and the distal free end of the tongue 22 comprising the retaining member 24 moves further into the pocket 14, as shown in FIG. 5B. Furthermore, the second surface 6 also pivots around fold 11, to allow the tongue 22 to move further into the pocket 14, by providing an effective spacing surface 13 as shown in FIG. 5B.

As the concertina sheet material 12 packs relatively flat, the first and second surfaces 8 and 6 may be folded over to provide a relatively flat credit-card sized sheet article 2.

When it is desired to remove the credit-card sized item present in the pocket 14, the first and second surfaces 8 and 6 are unfolded about the folds 10 and 11 until the first and second surfaces 8 and 6 are at an obtuse angle, as shown in FIG. 5A. As the first and second surfaces 8 and 6 are unfolded, the tongue 22 pivots about the pivot point 9 and is withdrawn to a certain extent from the pocket 14. Due to the presence of the retaining member 24, the credit-card sized item present in the pocket 14 is also withdrawn along with the tongue 22, such that a larger portion of the credit-card sized item extends beyond the opening 18 of the pocket 14. In this position, the credit-card sized item may be grasped by the user and removed from the sheet article 2.

Again, as in the embodiments of FIGS. 1 and 2, the orientation of the edge 18 of the opening of the pocket 14 towards the fold 10, means that when the sheet article 2 is in the folded position, the credit-card sized item is prevented from inadvertently slipping out or being removed by the restraining nature of the first and second surfaces 8 and 6 and the spacing surface 13.

In other embodiments similar to those described for FIGS. 3 and 4, the concertina sheet material 12 may be replaced by a booklet of leaves of paper, card or the like.

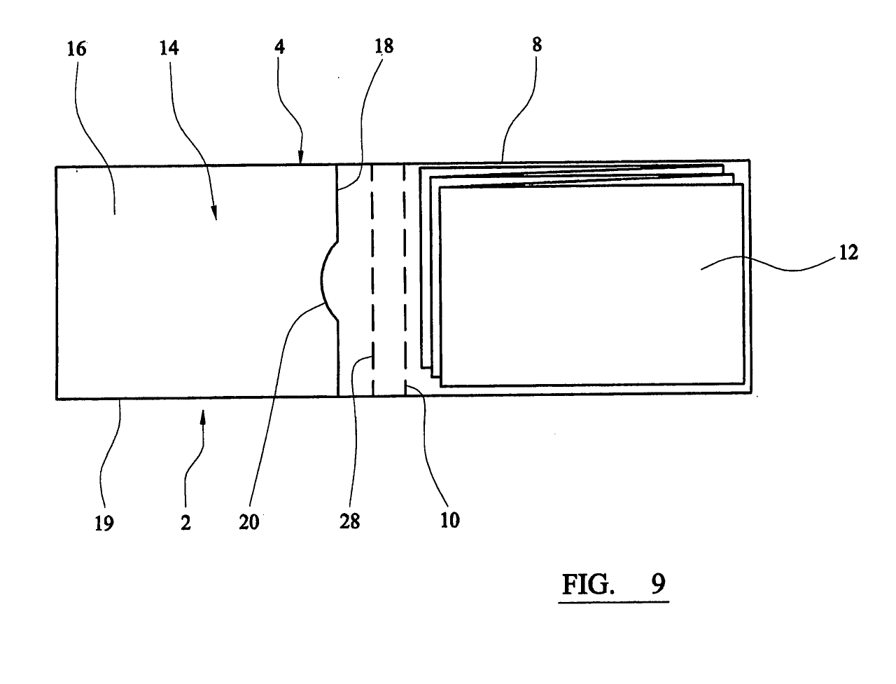

Referring now to FIG. 6, in a further preferred embodiment of the sheet article 2 according to the present invention, the tongue 22 is formed from a folded over portion 25 of the first surface 8 which has been glued to the first surface 8. The tongue 22 also comprises a pivot 26 in the form of a fold, which allows rotation of the tongue 22. Operation of the embodiment shown in FIG. 6 is essentially the same as operation of the embodiments shown in FIGS. 3, 4, 5A and 5B.

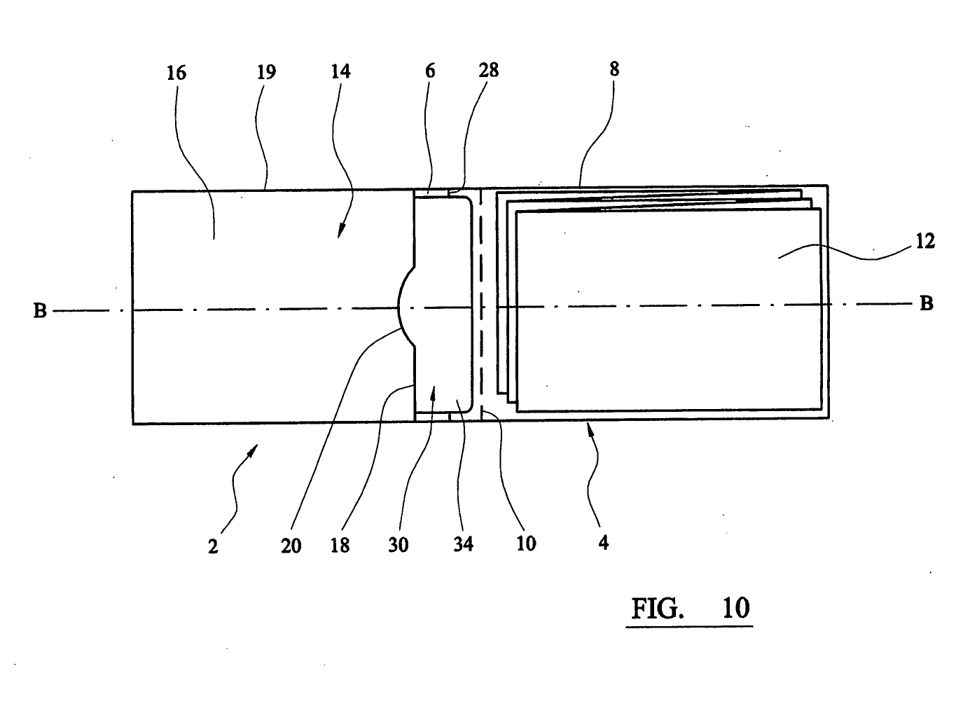

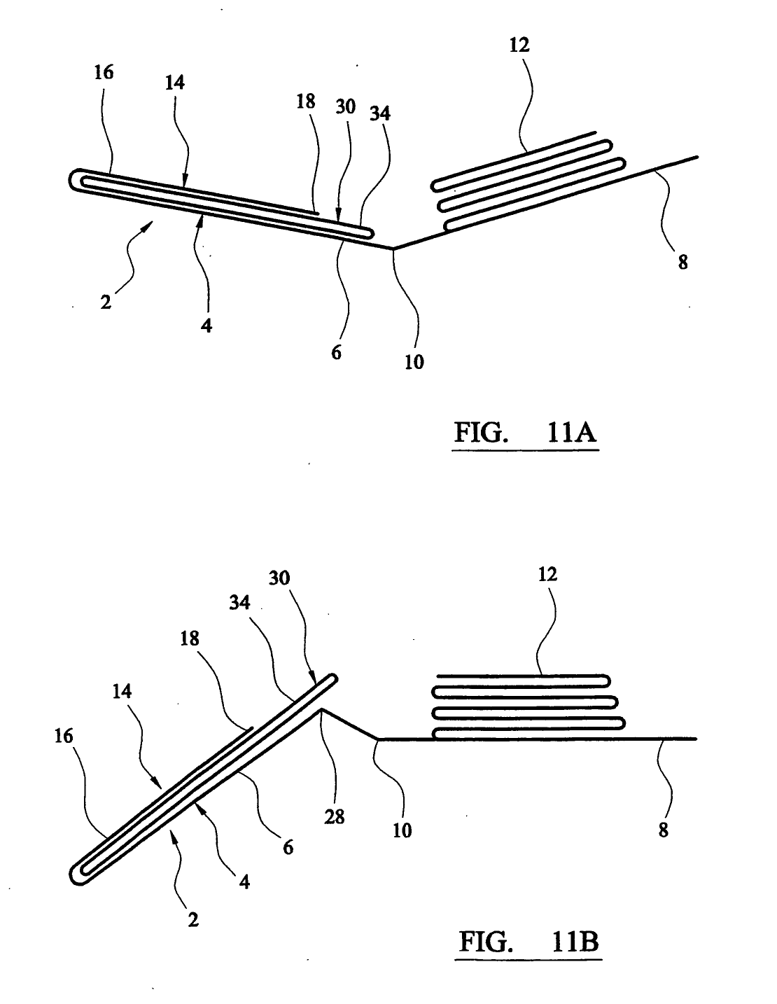

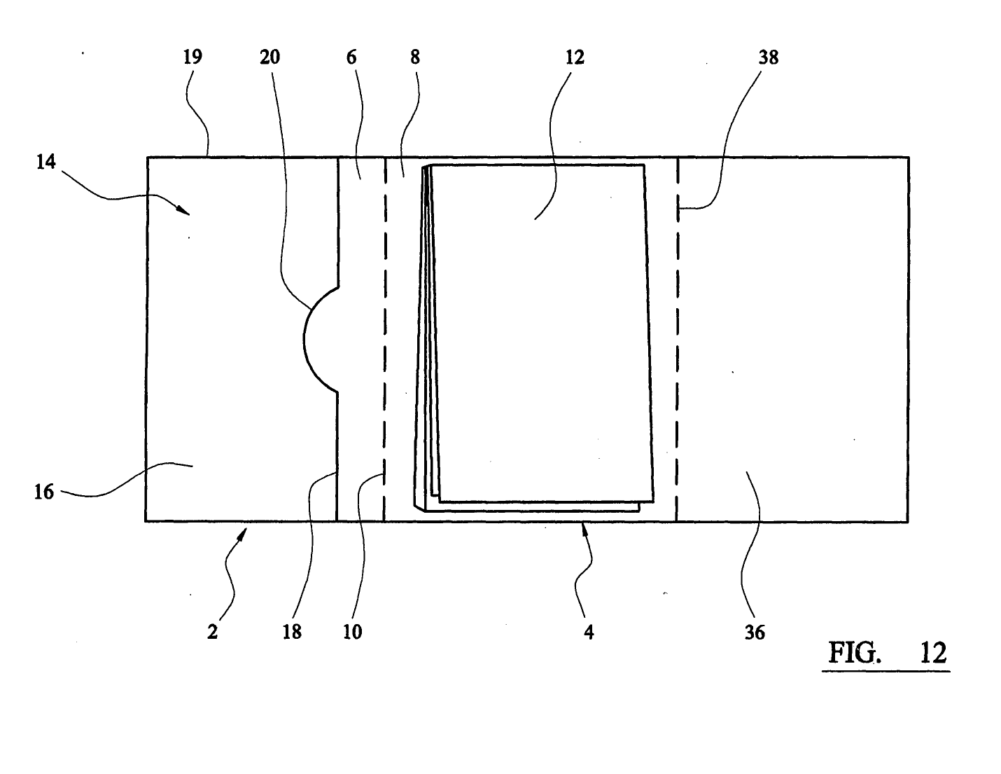

We refer now to FIGS. 7, 8, 9, 10, 11A and 11B, which illustrate sheet articles 2 which are similar to the sheet article 2 of the embodiments of FIGS. 1 and 2. Like numerals represent like components. In the embodiments of the sheet articles 2 of FIGS. 7 and 8, the cover 4 comprises a first surface 8 and a second surface 6 hinged by a fold 10 in the cover 4. The first surface 8 includes a second hinge 28 which is formed by a second fold in the cover 4. The second hinge 28 is located between the opening 18 of the pocket 14 and the fold 10. The distance which the second hinge 28 extends beyond the opening 18 of the pocket 14 is arranged such that an item such as a credit-card 30, inserted into the pocket 14, extends beyond the second hinge 28 on the first surface 8, as shown in FIGS. 9 and 10.

The difference between the embodiments shown in FIGS. 7 and 8 on the one hand, and FIGS. 9 and 10 on the other hand, is the size and orientation of the cover 4 and pocket 14. In the embodiments shown in FIG. 7 and 8, the size and orientation of the cover 4 and pocket 14 are such that a credit-card 30, or similar sized item, can be inserted such that one of its shorter edges protrudes from the pocket towards the fold 10 in the cover to display a marginal portion. In the embodiments shown in FIGS. 9 and 10, the size and orientation of the cover 4 and pocket 14 is such that one of the longer edges of the credit-card 30, or similar sized object is presented as a marginal portion.

The embodiments shown in FIGS. 7, 8, 9 and 10 are operated in a similar manner to those of FIGS. 1 and 2.

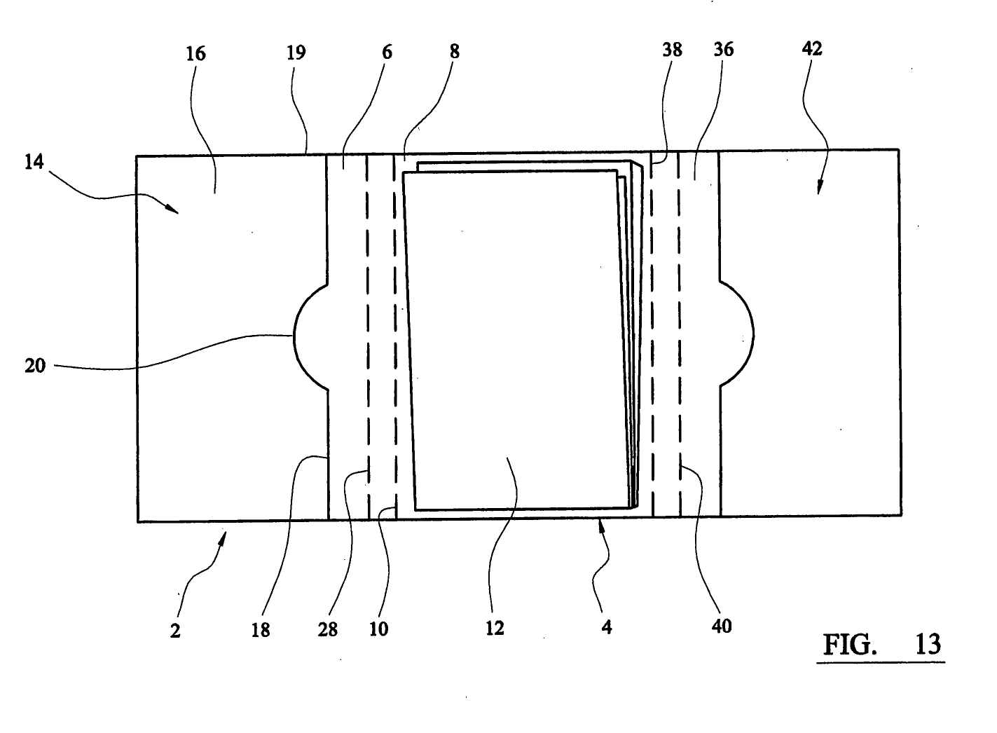

Referring now to FIGS. 11A and 11B, in use the cover 4 of the sheet article 2 is unfolded about the fold 10 such that the first surface 8 and second surface 6 lie at an obtuse angle to each other, as shown in FIG. 11A. A credit-card 30 or similar sized article can then be placed in the pocket 14, and if desired the cover 4 folded about the fold 10 to move the first and second surfaces substantially adjacent and flush.

When it is desired to remove the credit-card 30, the cover 4 is first unfolded to the position shown in FIG. 11A. Subsequently the distal portion of the first surface 8 is rotated about the second hinge 28 until the marginal portion 34 of the credit-card 30 is presented for easy withdrawal by a user, as shown in FIG. 11B. Due to the marginal portion 34 of the credit-card being presented at an angle to the plane of the second surface 6, a user can easily grasp the marginal portion 34 with his or her fingers without first having to try and lever the card or pocket opening 18.

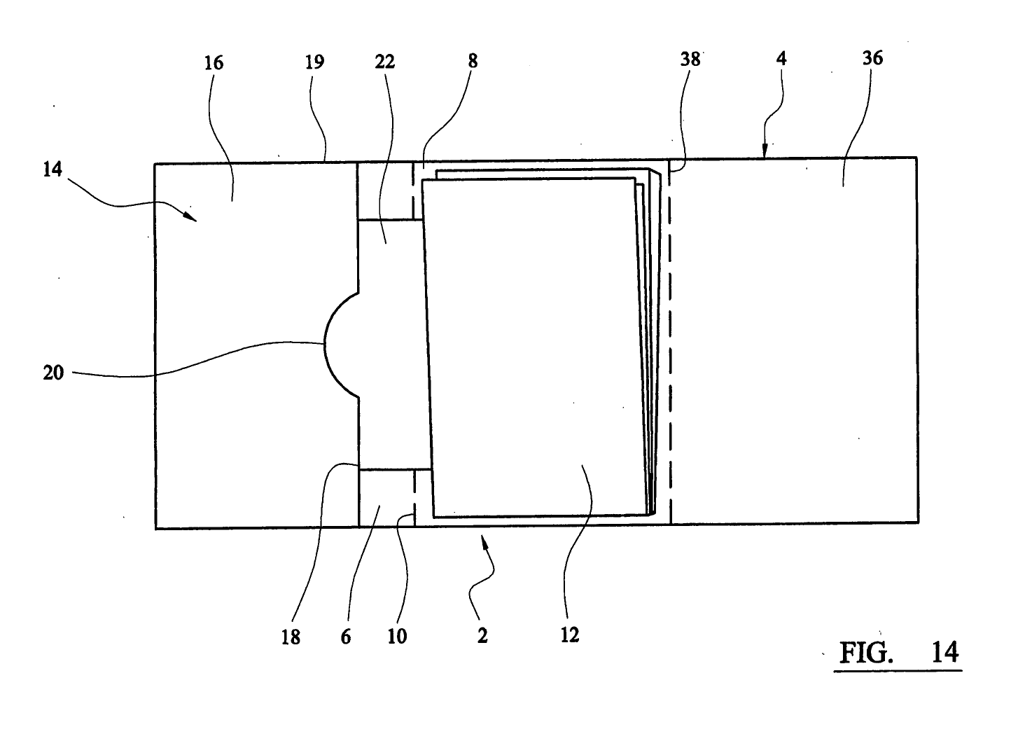

Referring to FIG. 12, an eighth embodiment of a sheet article is similar to the sheet articles of FIGS. 1 and 2. Like numerals represent like features.

The sheet article 2 of FIG. 12 has a cover which includes first 8 and second 6 surfaces, as in the embodiment shown in FIG. 1, and further includes a third surface 36, hingedly connected to the first surface 8 by way of a fold 38 between the first 8 and third 36 surfaces.

Use of the embodiment shown in FIG. 12 is similar to that for the embodiment in FIG. 1, with the exception that the second or third surface 6 or 36 may be folded about its respective fold 10 or 38 firstly, then the other of the second or third surface folded about its respective fold on top of the folded article.

The extra folded surface helps to prevent any article placed in the pocket 14 from inadvertently slipping out, or being removed.

In other embodiments, (not shown) a second pocket may be connected to the inside of the third surface 36 for retaining a further article or articles. Alternatively or additionally the third surface 36 may have a second sheet material connected to the inside of the surface, or on the second pocket, if present.

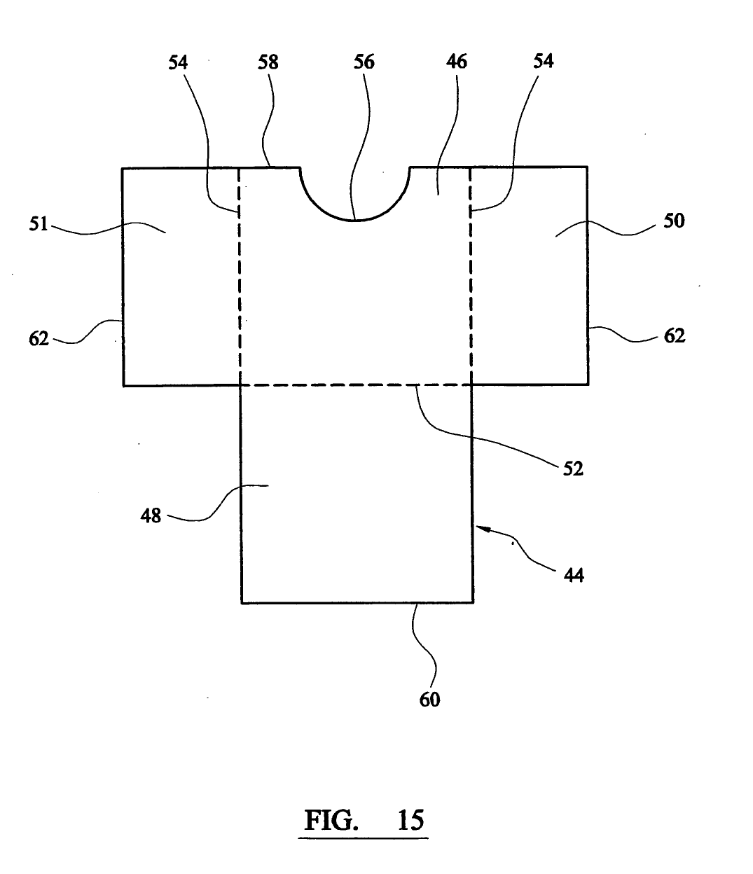

Referring to FIG. 13, a ninth embodiment of a sheet article is similar to the embodiments of FIGS. 7, 8 and 12. Like numerals represent like components.

The cover 4 of the embodiment illustrated in FIG. 13, includes a third surface 36, as described for the embodiment shown in FIG. 12. The second 6 and third 36 surfaces of the embodiment shown in FIG. 13 also include second hinges 28 and 40 respectively formed from folds in the second and third surfaces.

The third surface 36 also includes a second pocket 42.

Use of the embodiment shown in FIG. 13 is essentially a combination of uses of the embodiments in FIGS. 7 and 12. Thus, credit-cards or similar sized articles are placed in each of the pockets 14 and 42, such that a marginal portion extends beyond the folds 28 and 40 respectively. The sheet article can then be folded up as described for the embodiment in FIG. 12.

When it is desired to remove either or both credit-cards, the sheet article 2 can be unfolded about the folds 10 and 38 then the distal portions of the second and/or third surfaces 6 and 36 rotated about the folds 28 and 40 to present the margin of the credit-card out of the plane of the first surface 8 and/or third surface 36 for easy handling by a user.

In further embodiments, sheet material may be connected to either or both pockets 14 and 36.

Referring now to FIG. 14, a tenth embodiment is similar to the embodiments illustrates in FIGS. 4 and 12. Like numerals represent like components.

The sheet article 2 of FIG. 14 includes a third surface 36 of the cover 4, as described for the embodiment of FIG. 12, and a tongue 22 as described for the embodiment of FIG. 4.

Use of the embodiment shown in FIG. 14 is essentially a combination of the uses described for the embodiments of FIGS. 4 and 12.

In other embodiments similar to that illustrated in FIG. 14, the third surface may include a second pocket and a second tongue extending into the second pocket. The pockets on the second and third surfaces may include a connected sheet material. If there is no second pocket on the third surface, then a second sheet material may be connected directly to the inside of the third surface.

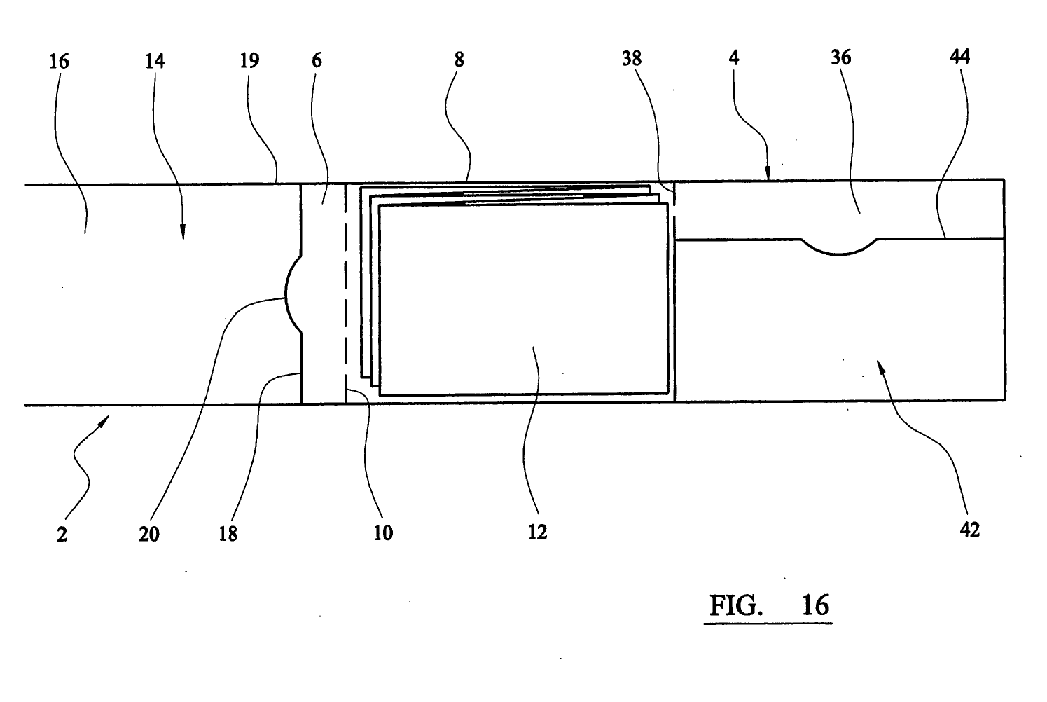

FIG. 15 illustrates a card sheet 44 which is suitable for forming a pocket to be connected to a sheet article according to the invention, which pocket does not have any internal edges extending into the pocket. Thus, an article deposited in the pocket cannot snag or catch on any raised edges, thereby damaging the pocket or making it harder to remove the article.

The card sheet 44 comprises a first 46, second 48, and third 50 and fourth 51 surfaces. The first surface 46 is hingedly connected to each of the second 48, third 50 and fourth 51 surfaces by way of folds 52 and 54 respectively in the card sheet 44. The second surface 48 is connected along the fold 52 between the lower edge of the first surface 46 and the upper edge of the second surface. The third 50 and fourth 51 surfaces are connected along the folds 54 at the side edges of the first surface 46. Thus the shape of the card sheet 44 is essentially cruciform with the third 50 and fourth 51 surfaces forming the arms of the cross, and the second surface 48 forming the stem.

The third 50 and fourth 51 surfaces have a width less than that of the first 46 and second 48 surfaces.

The first surface also comprises a cut-out portion 56 in its free edge 58.

In use, a pocket may be formed by firstly folding the second surface 48 about the fold 52 until the second and first surfaces lie substantially flush and parallel with the distal edge 60 of the second surface 48 lying substantially parallel with the free edge 58 of the first surface.

The third 50 and fourth 51 surfaces are then folded about the folds 54 on top of the second surface 48 and glued onto said second surface by a suitable adhesive. Thus a pocket is formed in which there are no internal edges in the pocket which extend into the pocket.

The pocket may then be connected to a sheet article according to the invention by any suitable means, such as gluing, stitching, stapling or the like, onto the inside of the first surface of the sheet article.

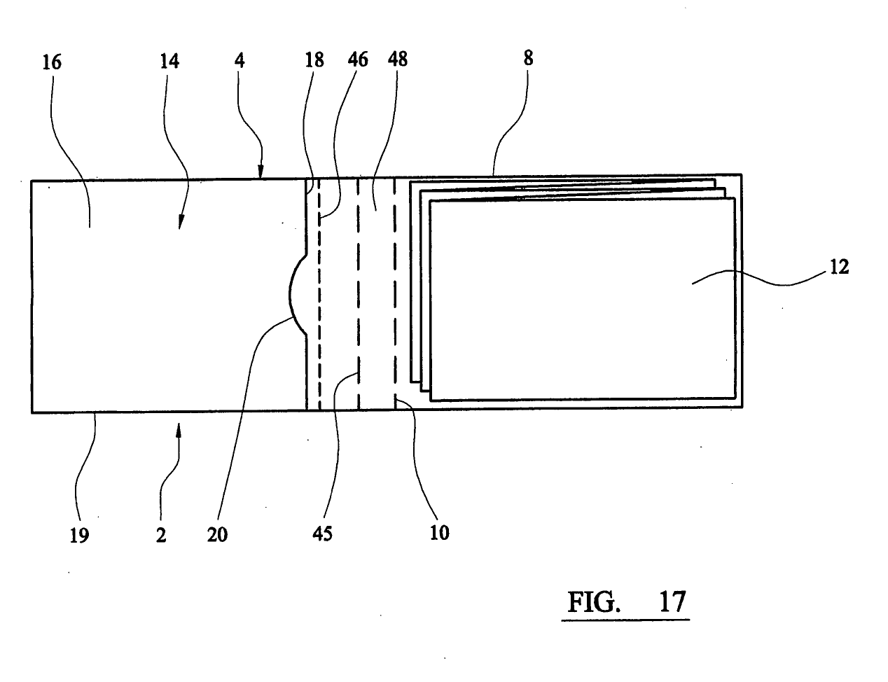

FIG. 16 illustrates a sheet article similar to that shown in FIG. 12. Like numerals represent like features. In the embodiment shown in FIG. 16 the sheet article 2 comprises first 8, second 6 and third 36 surfaces, connected in a landscape orientation. The third surface 36 comprises a second pocket 42 in which the opening 44 is orientated to face perpendicular to the folds 10 and 38. In this way, a credit card or similar item may be inserted in the second pocket 42 such that a longer edge of the credit card is inserted foremost.

In other embodiments similar to that of FIG. 16, the first pocket may include a tongue extending into the first pocket. The pockets on the second and third surfaces may also include a folded sheet material.

FIG. 17 illustrates an embodiment of a sheet article similar to that shown in FIGS. 7, 8, 9, 10, 11A and 11B. Like numerals represent like features. In the embodiment shown in FIG. 17, the sheet article comprises first 10, second 45, and third 46 folds in the cover 4. The second fold 45 is located in the same position as the second hinge 28 of the embodiments shown in FIGS. 7, 8, 9, 10, 11A and 11B. The third fold 46 is located on the second surface 6 between the opening of the pocket 18 and the second fold 45.

This embodiment is particularly useful for when the sheet material 12 projects a significant depth out of the first surface 8 when folded. In use, when the sheet material 12 is folded, the cover is first folded about the fold 10 to move the first 8 and second 6 surfaces towards each other. The cover 4 is then folded about the second fold 45 such that the cover forms a substantially C-shaped configuration with the surface 48 between the first 10 and second 45 folds forming the back of the C. Thus the back of the C-shaped configuration provides a space between the first 8 and second 6 surfaces in which lies the folded sheet 12. The third fold 46 is used in an identical manner to the second fold 28 of the embodiments of FIGS. 7, 8, 9, 10, 11A and 11B, to present an article located in the pocket 18, out of the plane of the second surface 6.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A sheet article comprising a cover comprising hingedly connected first and second surfaces, wherein on the inside of the cover is connected a sheet material having a first set of folds, and wherein the second surface comprises a pocket on the inside of the second surface, the opening of the pocket facing the hinged connection between the first and second surfaces.

2. A sheet article as claimed in claim 1, wherein the sheet material is connected to the inside of the first surface.

3. A sheet article as claimed in claim 1, wherein the first set of folds is concertina folds.

4. A sheet article as claimed in claim 1, wherein the sheet material further comprises at least one fold transverse to the first set of folds.

5. A sheet article as claimed in claim 4, wherein the at least one fold is a second set of folds.

6. A sheet article as claimed in claim 1, wherein the sheet material is connected to the first surface at a segment of the sheet at one corner of the sheet, the segment being defined by fold(s) or edge(s) of the sheet.

7. A sheet article as claimed in claim 1, wherein the sheet material is provided with a stiff portion at a segment thereof.

8. A sheet article as claimed in claim 7, wherein the segment at which the stiff portion is provided is at a corner of the sheet material and is defined by fold(s) or edge(s) of the sheet.

9. A sheet article as claimed in claim 1, wherein the first and second surfaces are formed from a single surface comprising a fold therein, the fold forming the hinged connection between the first and second surfaces.

10. A sheet article as claimed in claim 1, wherein the pocket is formed from a portion of the second surface folded in on itself, and sealed to the second surface to form a pocket.

11. A sheet article as claimed in claim 1, wherein the pocket is formed from a separate surface connected to the inside of the second surface of the cover such that an opening is formed.

12. A sheet article as claimed in claim 1, wherein the pocket comprises a separate distinct pocket which is attached to the inside of the second surface.

13. A sheet article as claimed in claim 1, wherein the pocket is formed such that it comprises no free edges within the interior of the pocket.

14. A sheet article as claimed in claim 1, wherein the edge of the opening of the pocket comprises a recessed or cut-out portion, to enable a user to more easily grasp an article placed in the pocket.

15. A sheet article as claimed in claim 1, wherein the pocket may comprise means to retard accidental egress of an article from the pocket, but allow deliberate removal therefrom.

16. A sheet article comprising a cover comprising hingedly connected first and second surfaces, and wherein the second surface comprises a pocket on the inside of the surface, the opening of the pocket facing the hinged connection between the first and second surfaces, and wherein the sheet article comprises a tongue extendable from the first surface into the pocket of the second surface, the distance of extension of the tongue into the pocket being adjustable by relative movement of the first and second surfaces about the hinged connection.

17. A sheet article as claimed in claim 16, wherein the sheet article further comprises a sheet material connected to the inside of the cover.

18. A sheet article as claimed in claim 16, wherein the sheet material is connected to the pocket on the inside of the second surface.

19. A sheet article as claimed in claim 16, wherein the sheet material is connected to the inside of the first surface of the cover.

20. A sheet article as claimed in claim 17, wherein the sheet material comprises a plurality of sheets which are connected to form a booklet.

21. A sheet article as claimed in claim 17, wherein the sheet material comprises a first set of folds.

22. A sheet article as claimed in claim 16, comprising a sheet material having a first set of folds.

23. A sheet article as claimed in claim 16, wherein the pocket is disposed on an inside of the second surface.

24. A sheet article as claimed in claim 16, wherein the first and second surfaces are formed from a single surface comprising a fold therein, the fold forming the hinged connection between the first and second surfaces.

25. A sheet article as claimed in claim 16, wherein the tongue comprises a portion of the first surface folded in on itself.

26. A sheet article as claimed in claim 15, wherein the tongue comprises a separate surface connected to the first surface of the cover.

27. A sheet article as claimed in claim 15, wherein the tongue comprises a retaining member for operatively retaining an article inserted into the pocket during movement of the tongue within the pocket.

28. A sheet article as claimed in claim 27, wherein the retaining member comprises a portion of the tongue folded in on itself to provide a recess in which an article may be retained.

29. A sheet article as claimed in claim 15, wherein the tongue is moveable between a first position in which a retained article protrudes a first distance from the pocket, and a second position in which a retained article protrudes a second distance from the pocket, and wherein the second distance is greater than the first distance.

30. A sheet article as claimed in claim 28, wherein when the tongue is in the first position a retained article does not protrude across the hinged connection between the first and second surfaces of the cover.

31. A sheet article as claimed in claim 29, wherein in the second position, a retained article may protrude past the hinged connection between the first and second surfaces.

32. A sheet article as claimed in claim 15, wherein the pocket is dimensioned such that it can accommodate credit card sized articles.

33. A sheet article comprising a cover comprising hingedly connected first and second surfaces, wherein the cover comprises a sheet material connected to the inside of the cover, the second surface comprises a pocket, with the opening of the pocket facing the hinged connection between the first and second surfaces, and wherein the second surface comprises a second hinge which is rotatable to enable a marginal portion of an item inserted into the pocket to be presented.

34. A sheet article as claimed in claim 33, wherein the pocket is connected on the inside of the second surface or the outside of the second surface.

35. A sheet article as claimed in claim 33, wherein the sheet material is connected to the inside of the first surface.

36. A sheet article as claimed in claim 33, wherein the sheet material comprises a plurality of sheets which are connected to form a booklet.

37. A sheet article as claimed in claim 33, wherein the sheet material is a sheet material comprising a first set of folds.

38. A sheet article as claimed in claim 33, wherein the sheet material comprises a first set of folds.

39. A sheet article as claimed in claim 33, wherein the second hinge is located between the opening of the pocket, and the hinged connection of the first and second surfaces.

40. A sheet article as claimed in claim 33, wherein the second hinge comprises a fold in the second surface.

41. A sheet article as claimed in claim 33, wherein the pocket is disposed on an inside of the second surface.

42. A sheet article as claimed in claim 33, wherein the first and second surfaces are formed from a single surface comprising a fold therein, the fold forming the hinged connection between the first and second surfaces.

43. (Cancelled)
